(19) United States
(12) Patent Application Publication
(10) Pub. No.: US 2025/0306048 A1
(43) Pub. Date: Oct. 2, 2025

(54) APPARATUS AND PROCESS FOR HANDLING AN EQUIPMENT-TRAY ASSEMBLY

(71) Applicant: MERCK PATENT GMBH, Darmstadt (DE)

(72) Inventors: Nathan OUTREMAN, MOLSHEIM (FR); Gael WAICHE, MOLSHEIM (FR); Philippe RIVAT, MOLSHEIM (FR); Joseph BURTON, MOLSHEIM (FR); Samuel DODANE, MOLSHEIM (FR)

(73) Assignee: MERCK PATENT GMBH, Darmstadt (DE)

(21) Appl. No.: 18/866,705

(22) PCT Filed: May 15, 2023
(86) PCT No.: PCT/EP2023/062886

§ 371 Date: Nov. 18, 2024

(30) Foreign Application Priority Data
May 18, 2022 (EP) 22305732.4

(51) Int. Cl. G01N 35/00; B01L 9/00; G01N 35/04; G01N 35/10

(52) U.S. Cl. CPC G01N 35/0099; B01L 9/50; G01N 35/10; B01L 2200/025; G01N 2035/00801; G01N 2035/009; G01N 2035/041

(57) ABSTRACT

The present invention relates to an apparatus and a process for handling an equipment-tray assembly. The present invention in particular concerns the fields of bioburden testing, water testing, pharmaceutical, cosmetics, food processing, semiconductor production, electronics, and environmental monitoring of closed processing areas.

### TECHNICAL FIELD

The present invention relates to an apparatus and a process for handling an equipment-tray assembly. The present invention in particular concerns the fields of bioburden testing, water testing, pharmaceutical, cosmetics, food processing, semiconductor production, electronics, and environmental monitoring of closed processing areas.

### BACKGROUND

In the related processes laboratory testing equipment like filtration funnels, filters, cups, collection media, for example in the form of petri-dishes, media plates or settle plates (the term “equipment” will be consistently and collectively used in this specification to refer to all such devices used in testing, wherein “filtration funnels” will be used later as a specific example to explain the concept of the invention), have to be transferred repeatedly between working places or into a closed production area and removed therefrom for further handling and evaluation, preferably by an automated system. Today, this is still commonly done in a manual process wherein one or more pieces of such equipment are conveyed manually, for example through an aseptic transfer port into and out of the interior of the processing or production area.

However, the manual handling of such equipment involves a risk of contamination during handling, for example after a lid, cover or seal has been opened, and a non-secure transfer of the media plates during introduction, installation, removal and further handling, in particular when the equipment is filled with substances and/or a plurality of them are handled at once as a set or batch or group, for example in a stack.

Further, maintaining several pieces of equipment like petri-dishes in a group during a sequence of processing steps is moreover a complex task and requires measures like taping or bundling several petri-dishes together and/or marking them.

Further, the individual pieces of equipment like filtration assemblies (which typically comprise a membrane support holding a filtration membrane and a filtration funnel releasably attached to the membrane support), membrane supports, filtration funnels or petri-dishes as such are not particularly suitable for automated handling in batches or stacks. It is difficult for automated handling equipment to securely grip, hold and transfer the frequently smooth cylindrical peripheral surfaces of the equipment or of its parts like a lid/cover as they require a defined position and orientation for gripping, and there is a high risk that lids are inadvertently opened, displaced, or removed or contents spilled during handling at the various stages of the process, thereby compromising the detection result.

Thus, to facilitate and secure the handling of several pieces of equipment one or more piece of such equipment, in particular filtration assemblies but also individual pieces of the above-described type, are releasably but firmly mechanically held in respective receptacles on a tray or a support frame (the term “tray” will be consistently and collectively used in this specification to refer to all such devices that provide a support for the handling, particularly for transporting and/or storing, for example, also during incubation, of one or more pieces of equipment releasably held) to form an equipment-tray assembly.

Further, in the following disclosure, the term “piece of equipment” collectively refers to the above-mentioned pieces of testing equipment or parts thereof typically used in the above-described fields of application, whereby a most preferred application concerns the handling of filtration assemblies, and in this context, more specifically, the separation of the filtration funnel (representing a part of the filtration assembly) from the membrane support as described below. It is understood, however, that the invention is also applicable to the separation of the entire filtration assembly from the tray or of other parts like the membrane support or of other types of equipment as described above from engagement with the tray or from engagement with other components which remain held in the tray.

The pieces of equipment E are, for example, clipped or snapped on the tray for storage and transport purposes and a force required to overcome a holding force or friction force to release an individual piece of equipment from its receptacle on the tray or to release a part of the assembly like the filtration funnel from another part of the assembly like the membrane support with which it is assembled may, for example, be on the order of about 80 N. An example of such an equipment-tray assembly A in the form of an array of four filtration assemblies FA on a tray or frame T is shown in FIGS. 1a to 1c. The filtration assemblies FA are respectively formed as a unit by a membrane support S at the bottom holding a filtration membrane (not shown) on its top side, and a filtration funnel F releasably attached to the top side of the membrane support S. The filtration funnel F is typically closed at its upper open end by a lid L. The filtration assemblies FA, the membrane supports S, filtration funnels F and lids L are each referred to as “piece of equipment E”.

The pieces of equipment or parts thereof are commonly separated one by one by an operator. These tasks are critical in the process and require a high level of care and attention to repeatedly perform the task without fail due to the risks, for example, of cross-contamination or accidental disassembly of a unit (e.g. a filtration assembly). Handling devices (e.g. robot arms) may be employed but must also preserve the integrity of the equipment during the process. For example, equipment parts like filtration funnels must not be disassembled (even partially) or contaminated while being separated from the membrane support retained on the tray and/or the membrane support must not be unintentionally removed from its receptacle during separation of the filtration funnel.

Automation is becoming a privileged approach used by, for example, pharmaceutical companies in their critical processes in order to reduce the risk of cross-contamination, increase quality and improve throughput. There is a general industry trend towards fully automatized processes.

Nevertheless, the automation of a process requires a significant level of investment and available space to comply with regulations. Automation cells can be large systems with potentially dangerous devices.

This is why a specific way to automate certain processes requires designing small integrated dedicated modules able to perform specific tasks. Such systems may be designed to fit into an existing lab infrastructure and greatly facilitate their integration therein. As further example mention may be made of collaborative robots as these robots can safely interact with humans and thus can be more easily integrated into a laboratory or production environment.

What is desired is an at least partly or preferably fully automated apparatus and process for handling the above described equipment-tray assemblies on which one or more pieces of testing equipment are grouped and securely held on respective receptacles of a tray for transport and handling, wherein the apparatus and process do not involve human handling steps or interaction for installing the equipment-tray assembly and for separating the individual pieces of equipment or parts of such individual pieces of equipment from their receptacles on the tray or from an assembly combining two or more of such parts.

### SUMMARY

The present invention thus provides an apparatus for handling an equipment-tray assembly as defined by claim 1 and a process for handling an equipment-tray assembly as defined by claim 11. Preferred embodiments are defined in the respective dependent claims.

The present invention thus in particular provides an apparatus for handling an equipment-tray assembly which preferably has one or more pieces of equipment held in respective receptacles on a tray, comprising a support for receiving the equipment-tray assembly and provided with locking means for releasably mechanically securing the tray in a defined working position; and a separation mechanism for mechanically detaching/separating one or more pieces of equipment from the receptacle/receptacles on the tray against a holding force/resistance or for mechanically detaching/separating a part of one or more pieces of equipment from another part with which it is engaged to form a unit while the other part remains held in the receptacle/receptacles on the tray against a holding force/resistance.

Preferably, the locking means for releasably mechanically securing the tray in the working position is configured to engage the tray and actively position the tray into the defined working position.

Preferably, the locking means for releasably mechanically securing the tray in the defined working position comprises a suction device for gripping a surface of the tray by creating a sub-ambient pressure and for moving the gripped tray into the defined working position.

Preferably, the apparatus further comprises a means for monitoring the sub-ambient pressure state of the suction device.

Preferably, the locking means for releasably mechanically securing the tray in the defined working position comprises a mechanical latch for releasably locking the tray in the defined working position.

Preferably, the separation mechanism comprises a pushing member for selectively applying a pushing force to a bottom or periphery of the piece of equipment or the part of the unit to overcome the holding force/resistance holding the piece of equipment in the receptacle of the tray or the holding force/resistance engaging the part of the piece of equipment with the other part to form the unit.

Preferably, the pushing member is configured to initially apply the pushing force at an off-centered position to the bottom or periphery of the piece of equipment or the part thereof.

Preferably, the pushing member comprises one or more ejector pins configured to be selectively, preferably phase shifted, urged against the bottom or periphery of the piece of equipment, preferably by a linear actuator configured to move one or more ejector pins against the bottom or periphery of the piece of equipment or the part thereof or by a rotary actuator in combination with a cam mechanism arranged to linearly drive the one or more ejector pins or by a linear actuator in combination with a lever arm bearing the ejector pin/pins.

Preferably, the apparatus further comprises a sensor arrangement for monitoring the presence of the tray at the support, at the defined working position and/or for monitoring/detecting the presence/absence of one or more pieces of equipment at the receptacles on the tray.

Preferably, the apparatus further comprises a controller configured to, in accordance with the monitoring/detection result of the sensor arrangement, issue a warning and/or operate the locking means and/or the separation mechanism.

The invention also provides a process for handling an equipment-tray assembly which has one or more pieces of equipment held in respective receptacles on a tray, preferably using the apparatus according to the invention, the process comprising placing the equipment-tray assembly on a support and releasably mechanically securing the tray in a defined working position, and mechanically detaching/separating one or more pieces of equipment from their receptacle/receptacles on the tray against a holding force/resistance or for mechanically detaching/separating a part of one or more pieces of equipment from another part with which it is engaged to form a unit while the other part remains held in the receptacle/receptacles on the tray against a holding force/resistance.

Preferably, the detaching/separating of the one or more pieces of equipment comprises selectively applying a pushing force to a bottom or a periphery of the piece of equipment or the part thereof to overcome the holding force/resistance holding the piece of equipment in the receptacle of the tray or the holding force/resistance engaging the part of the piece of equipment with the other part to form the unit.

Preferably, the pushing force is initially applied at an off-centered position to the bottom or periphery of the piece of equipment or the part thereof.

Preferably, the process further comprises monitoring the presence of the tray at the support, at the defined working position and/or monitoring/detecting the presence/absence of one or more pieces of equipment at the receptacles on the tray.

Preferably, the process further comprises issuing a warning and/or initiating the securing of the tray in the defined working position and/or the detaching/separating of the one or more pieces of equipment from their receptacle/receptacles or of the parts thereof from the other parts of the respective unit in accordance with the monitoring/detection result.

Preferably, the releasably mechanical securing of the tray in the defined working position is made by creating a sub-ambient pressure to grip the tray and moving the gripped tray into the defined working position, and/or by engaging a mechanical latch with the tray placed on the support.

### BRIEF DESCRIPTION OF THE DRAWINGS

The present invention will in the following be described in detail on basis of the preferred but non-limiting embodiments by reference to the attached exemplary schematic drawings, in which

FIGS. 1a to 1c are schematic exemplary representations of perspective views of an example of an equipment-tray assembly in the form of an array of four filtration assemblies held in respective receptacles on a tray or frame and a side view of the isolated filtration assembly;

FIGS. 2a to 2g are schematic exemplary representations of a series of sequential process steps performed by an apparatus for handling an equipment-tray assembly using the tray with filtration assemblies of FIGS. 1a to 1c as an example;

FIG. 3 is a schematic exemplary representation of a locking means and of a separation mechanism of an apparatus for handling an equipment-tray assembly according to an embodiment;

FIG. 4 is a schematic exemplary representation of a locking means and of a separation mechanism of an apparatus for handling an equipment-tray assembly according to another embodiment; and

FIG. 5 is a schematic exemplary representation of a locking means and of a separation mechanism of an apparatus for handling an equipment-tray assembly according to still another embodiment.

### DETAILED DESCRIPTION

The apparatus and process for handling an equipment-tray assembly of the invention provides a means for a partly or preferably fully automated handling of an equipment-tray assembly and of the one or more pieces of equipment (i.e. filtration assemblies comprising a membrane support and a filtration funnel releasably attached to the membrane support to form a unit) held on the receptacles of the tray in order to reduce or preferably avoid disassembly of a piece of equipment (unit) during the separation and handling of the entire piece of equipment as a unit or of a part thereof (e.g. of the filtration funnel).

The apparatus in particular supports putting the tray in a defined mechanical reference which is suitable for automation of handling of the pieces of equipment and physically or mechanically locks the tray in place. Thus, the pieces of equipment can be safely mechanically separated and detached from their receptacles or from the unit without human action and presented to a robot or an automated machine or even a human operator in a controlled, secured and highly repeatable process, without the risk of losing them from the tray and/or disassembling the unit.

In a preferred embodiment, information on the process steps can be collected, e.g. if the tray or piece of equipment is/remains in position and if the equipment has been properly disassembled, and this information can be used for warnings or documentation or control of the operation of the components of the apparatus to improve the safety and reliability of the process.

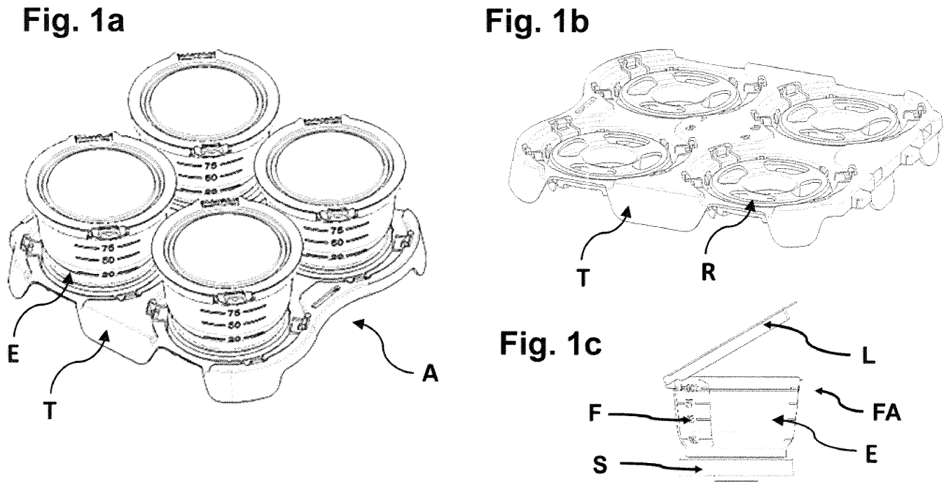

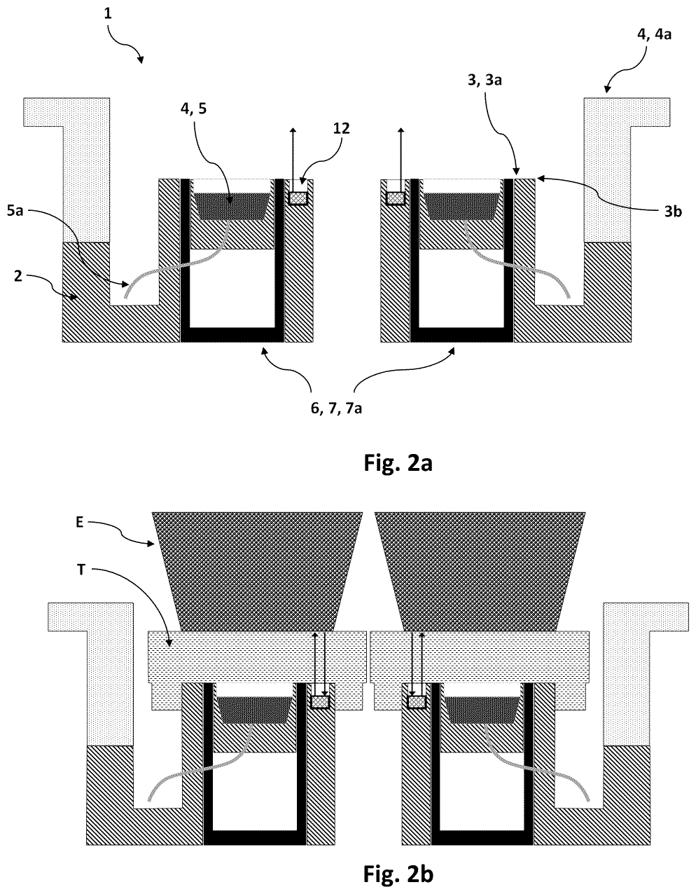

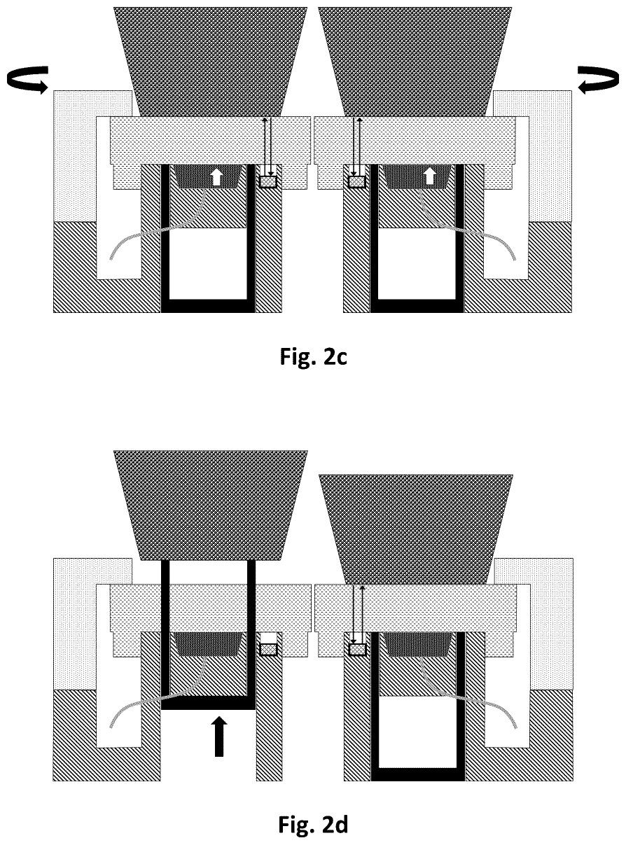

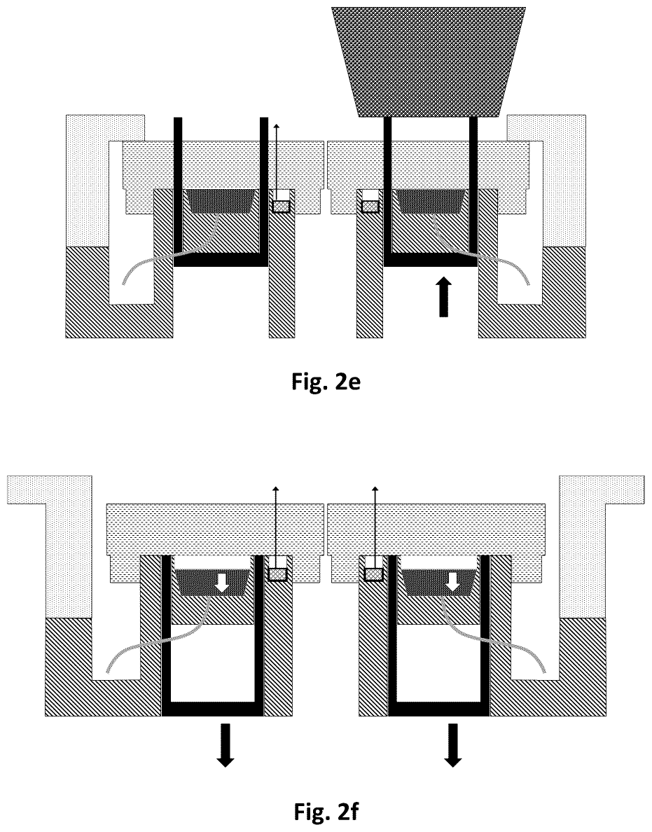

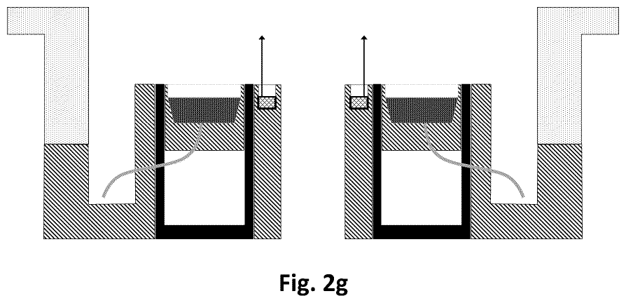

An apparatus 1 for handling an equipment-tray assembly A (which has one or more pieces of equipment E held in respective receptacles R on the tray T as described above in connection with FIGS. 1a to 1c) is schematically shown in FIG. 2a and comprises a support 3 for receiving the equipment-tray assembly A, a locking means 4 for releasably mechanically securing the tray T in a defined working position and a separation mechanism 6 for mechanically detaching/separating one or more pieces of equipment E from their receptacle/receptacles R on the tray or (as in this example) for mechanically detaching/separating a part (i.e. the filtration funnel representing the piece of equipment E) from another part of the filtration assembly representing a unit (i.e. from the membrane support that is to remain attached to the receptacle/receptacles R on the tray) against a holding force/resistance (see FIGS. 2d and 2e).

The support 3 for the tray comprises a mechanical reference for accurate positioning, a means to locate the tray in space, and a means to hold the tray in position. The shape of the support 3 is not particularly limited. The equipment-tray assembly A can be placed on the support 3 of the apparatus manually, by gravity in combination with a conventional automated conveyor, or by a dedicated actuator or robot arm.

As schematically shown, the support 3 may comprise a base or post 3a on which the tray can be placed, thereby defining its position in the vertical direction. The tray can be located in space and mechanically referenced by a number of spaced apart protrusions or stoppers 3b in defined positions around the tray so as to cooperate, for example by mechanical engagement, with defined sections of the tray when the same is in the desired position, thereby defining the tray position in the horizontal plane (see FIG. 2b).

The locking means 4, for example in the form of one or more movable mechanical latch(es) 4a, is provided to selectively engage with the tray when the same is in the correct position on the support 3. In FIG. 2c an example is shown where the latch 4a is rotated or pivoted from a stand-by position on a side of the tray until it extends above the upper surface of the tray, thereby preventing lifting of the tray in the vertical direction from the support 3.

The locking means 4 for releasably mechanically securing the tray T in the working position is thus configured to selectively engage the tray T. It may also be configured to actively position the tray T into the working position in a lateral direction (i.e. in the horizontal plane) and/or in the vertical direction. In the exemplary apparatus shown in FIGS. 2a to 2c the locking means 4 for mechanically securing the tray T in the working position comprises a suction device 5 in the form of one or more vacuum or suction cup(s) or pad(s) configured to grip a lower surface of the tray resting on the support 3 by creating a sub-ambient pressure and for moving the gripped tray into the working position, for example by pulling it downward by suction only or by active movement under electrical or pneumatic activation of the suction device 5 until the tray fully rests on the support 3 (see FIG. 2c). In this position the mechanical latch 4a can perfectly pass above the top surface of the tray for releasably locking the tray in the working position. It is noted that suction device 5 may be connected by means of a connection 5a, for example, by tubing or piping, to a vacuum pump (not shown) or any other means capable of creating sub-ambient pressure in the suction device 5.

The mechanical latch(es) 4a can be dispensed with if the holding force of the suction device 5 is alone sufficient to maintain the tray in place even if the pieces of equipment require a relatively high force (for example in the range of 80 N) to be ejected from their receptacle by the separation mechanism 6 as described below. It is, however, preferred to additionally provide the mechanical latch(es) in order to avoid accidental release of the tray in case the sub-ambient pressure level is lost due to failure of a seal state over time due to contamination or temperature changes or failure of a vacuum source.

Of course, the latches 4a may also engage with dedicated recesses or protrusions formed at the periphery of the tray instead of the top surface. The contact surface of the latch 4a with the tray T or vice versa may also be provided with an inclination or cam face that is formed so as to progressively push the tray into its defined working position on the support 3 in a lateral direction and/or downward direction during the progressing engagement process (for example by pivoting the latches 4a), thus assisting or replacing the function of the suction device 5.

The apparatus may include a means for monitoring the sub-ambient pressure state or pressure level of the suction device 5, i.e. of each suction cup in order to confirm that the gripping state is successful. The monitoring result can be used as a trigger or input signal for activating the locking means 4, thus providing an automated process for securing the tray in the working position.

The vacuum of the suction cups may be monitored during the complete process. For example, not reaching the right vacuum level within a certain period after placing the tray on the support may indicate that the tray has been misplaced or is broken or cracked. Or, for example, loss of vacuum during the separation process may indicate that the tray has been broken or detached during the operation. The right vacuum level guarantees the tray's correct mechanical positioning and integrity.

The separation mechanism 6 of the apparatus comprises one or more pushing member(s) 7 for selectively applying a pushing force from below the tray T to a bottom of the piece of equipment E or to a part thereof (the filtration funnel of the filtration assembly in this example) to overcome a holding force/resistance holding the piece of equipment E in the receptacle R of the tray T or to overcome a holding force/resistance holding the part attached to another part of a unit (the membrane support of the filtration assembly in this example) while this other part remains held in the receptacle of the tray. The pushing members 7 can be provided for each position of a receptacle or associated to a receptacle or for several receptacles in common and several pushing members 7 may be configured to be independently or jointly activated.

The pushing members 7 in the embodiment of FIGS. 2a to 2g are formed as protruding pushers 7a that are linearly movable parallel to the vertical direction perpendicular to the plane of the tray. The protruding pushers 7a may be in the form of a cup in a case where the entire piece of equipment is to be separated from the receptacle or, as in the example, in the form of a base member with one or more pin-like protrusions (two of which are shown in the cross-sectional view of FIGS. 2a to 2g) which may pass through corresponding openings in the tray in the case of the example where the part is to be detached from the other part of the unit. In the case of providing plural pin-like protrusions the piece of equipment is engaged at its lower side at several positions equally distributed about a center of the piece and pushed upward parallel to the vertical direction (see FIGS. 2d and 2e). This arrangement can work satisfactorily if the holding force of the pieces of equipment in their receptacles (or at the other part of the unit) is not very high or if the holding force is mainly created by friction.

It is preferable, however, in particular if the pieces are somewhat locked or clipped in the receptacle or the other part of the unit by a form-locking resilient snap connection, that the pushing member(s) 7 is/are configured to initially apply the pushing force at an (for example, one) off-centered position to the bottom of the piece of equipment E in the respective receptacle(s). Thereby, the piece of equipment (the part) is tilted and initially released and lifted at one side while remaining initially held at the tray or at the other part of the unit at an opposite side. The pushing member in this case does not have to provide the force required to release the entire piece of equipment (part) at once (for example, in a single step) but only a portion of it, thus avoiding that the piece is pushed past a snap connection and suddenly “pops” out from the receptacle or from the other part of the unit in an uncontrolled manner. The non-symmetrical application of the pushing force is also preferable in the described situation of removing the part from the other part of the unit because the other part (i.e. the membrane support in the example) is to remain held in the tray and may not be dislodged when the part is removed (it is noted that the holding force between the parts of the unit to be separated will be typically designed to be lower than the holding force between the receptacle of the tray and the other part but the level of force required is not precisely predictable and varies depending on dimensional variations of the mating engaging portions of the parts or environmental influences).

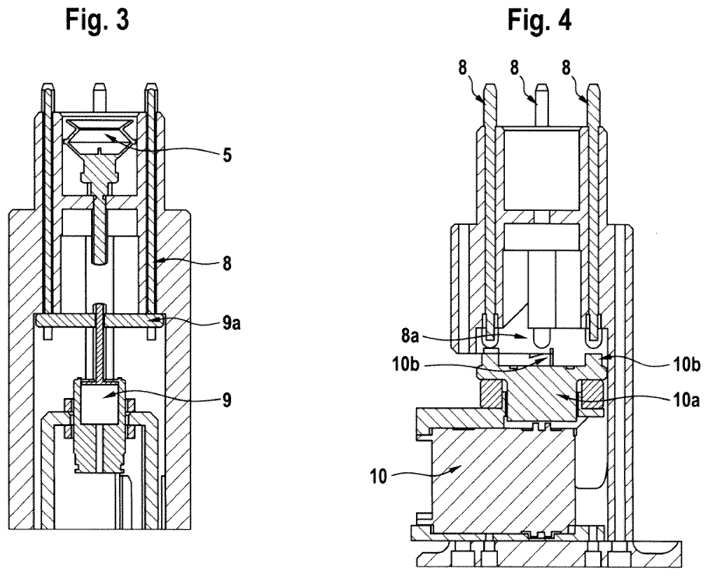

As an alternative to the pushers 7a that are cup shaped or have plural protrusions of equal height as shown in the example of FIGS. 2a to 2g, the pushing member 7 may comprise one or more ejector pins 8 configured to be urged from below against the bottom of the piece of equipment (or part), preferably by an actuator. The embodiment of FIG. 3 has a linear actuator 9 configured to move a plate 9a in the vertical upward/downward direction and the plate 9a in this case has a number of ejector pins 8 erected on the plate 9a in distributed positions that conform to the bottom of the piece or part or to a lateral position at the periphery. The ejector pins 8 may be of equal height (in which case the piece is pushed symmetrically about its center) or the pins may have slightly different heights (in which case the pushing force is initially applied at an off-centered position to the piece to create the above-mentioned initial tilting despite of the synchronous upward movement of all pins).

If a linear actuator is provided for each ejector pin 8 (not shown), the actuators may be either simultaneously and synchronously or sequentially (phase shifted) operated and urged against the bottom or periphery of the piece of equipment or part (not shown). In terms of stability three ejector pins 8 might be preferred in an equal spacing but the number and in particular the shape is not particularly limited for the purposes of the invention.

In the embodiment of FIG. 4 the actuator is a rotary actuator 10 (i.e. an electrical rotating servo motor) arranged to rotate a cam mechanism including a plate 10a and a number of cam surfaces 10b erected on the plate 10a and configured to engage with a lower end 8a of a respective ejector pin 8, thus individually moving the pins 8 upward and downward in the vertical direction. Again, the arrangement and shape of the cam surfaces 10b can be adapted so that all the pins are pushed up simultaneously or with a phase shift to create the initial tilt of the piece or part. This embodiment creates a smooth movement of the pins and thus of the piece/part, and the servomotor, for example, allows a precise control and modulation of the stroke, speed, and strength.

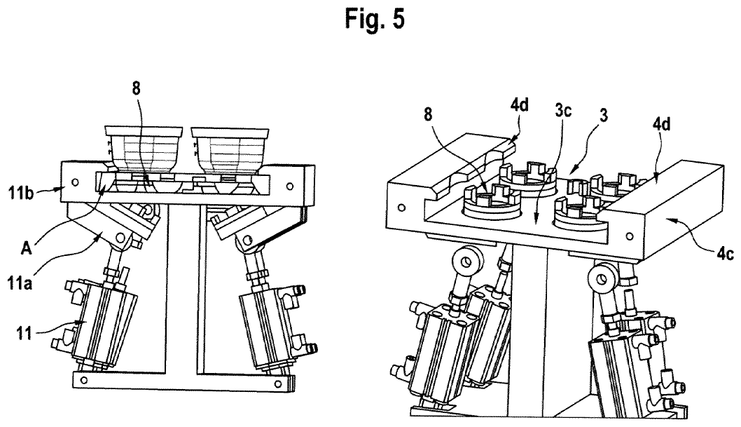

In the embodiment of FIG. 5 the actuator is a linear actuator 11 that is provided in combination with a lever arm 11a bearing the ejector pin/pins 8. The extension of the linear actuator 11 pivots the lever arm 11a that is rotatably supported on the apparatus at a pivot 11b on one end until the one or more pins or protrusions 8 (which can be relatively short in this case if the pivot arm is provided close to the support of the tray) push against the bottom or periphery of the piece or part (i.e. the filtration funnel in the example) from below and progressively push on the piece or part with an angle. In the embodiment of FIG. 5 the support 3 and locking means 4 are provided as a simple mechanical holder without movable parts and are formed by a pair of upstanding side rails 4c with prongs or protrusions 4d projecting from opposite sides. The tray in this case can be slid below the prongs or protrusions in order to be attached and held on the support 3 in a situation where the lever arms 11a are in a retracted state such that the pins or protrusions 8 are located below the surface 3c of the support 3.

The apparatus may further comprise a sensor arrangement for monitoring the presence of the tray T at the support 3, at the defined working position and/or for monitoring/detecting the presence/absence of one or more pieces of equipment E in/at their receptacles R on the tray T. Suitable sensors may be contact sensors (i.e. micro switches) or contactless sensors or switches (i.e. ultrasonic sensors, light sensors, image pickups) and the sensors may be selected and arranged according to the respective situation and circumstances and accessibility. In FIGS. 2a and 2d several contactless light sensors are exemplified as the sensor arrangement 12 below the support 3 and the tray T to detect the presence/absence of the funnels at the respective receptacles.

A controller may be provided and configured to, in accordance with the monitoring/detection result of the various sensors in the sensor arrangement, issue a warning and/or operate the locking means and/or the separation mechanism in order to create an automatic process.

After the pieces of equipment are removed and discharged from the tray, for example by conventional automated conveyors, robot arms or manually, the (empty) tray is released from the locking means 4 (for example by interrupting the vacuum at the suction devices 5 as exemplified in FIG. 2f and disembarked from the support 3 by an ejection arm, a robot arm or conventional automated conveyors or again, manually.

An exemplary process for handling an equipment-tray assembly using a tray T with pieces of equipment E in the form of filtration assemblies or units formed from a filtration funnel releasably attached to and thus combined with a membrane holder to form a unit as shown in FIGS. 1a to 1c is schematically shown in FIGS. 2a to 2g.

FIG. 2a shows the present apparatus 1 for handling an equipment-tray assembly in its initial or starting state, with locking means 4 in open or stand-by position.

Subsequently, as shown in FIG. 2b, the tray T comprising one or more pieces of equipment E held in respective receptacles is placed onto support 3, preferably with the aid of base or post 3a to a pre-defined (correct) position on support 3.

In the following, as schematically illustrated in FIG. 2c, locking means 4 are engaged so as to position and hold tray T in a working position. To this end, latch(es) 4a of locking means 4 may selectively engage as described above with the tray T, for example, by rotating or pivoting (as indicated by the circular arrows in FIG. 2c) latch(es) 4a from the stand-by position (e.g. on a side of the tray) until extending above the upper surface of the tray T. Alternatively or in addition, and either before or after or parallel to the engagement of latch 4a with the tray T, suction device(s) 5 are moved from their stand-by position, are brought into contact with the lower surface of tray T, and, upon creation of sub-ambient pressure, are gripping the lower surface of tray T and move the tray T into a working position.

As explained previously, latch(es) 4a and suction device(s) 5 may be used either in combination or individually to position and hold tray T in the working position.

Once tray T is locked into the working position, as shown in FIG. 2c, pushing member(s) 7 selectively apply a pushing force from below the tray T to the bottom or periphery of the piece of equipment E (be it the filtration assembly of the part thereof), as is schematically illustrated in FIGS. 2d and 2e, such force being chosen to be sufficiently strong to overcome the holding force/resistance holding the piece of equipment E in the respective receptacle R of tray T or the holding force/resistance holding the part of the unit engaged with another part that is to remain held in the receptacle, upon which the pieces of equipment are removed, for example, by a robot.

It is noted that, for two or more pieces of equipment E held in the respective receptacles R of tray T, pushing members 7 associated with each respective receptacle may be actuated sequentially or simultaneously.

As shown exemplarily in FIG. 2f, following the removal of the pieces of equipment E, and—if applied—breaking the sub-ambient pressure, locking device(s) 4—if used—, suction device(s) 5—if used—, and pushing member(s) 7 are returned to their stand-by or starting positions.

Eventually (see FIG. 2g), the tray T may be removed, thereby bringing the apparatus 1 back into its initial or starting state.

1. An apparatus (1) for handling an equipment-tray assembly (A) which preferably has one or more pieces of equipment (E) held in respective receptacles (R) on a tray (T), the apparatus (1) comprising
a support (3) for receiving the equipment-tray assembly (A) and provided with locking means (4) for releasably mechanically securing the tray (T) in a defined working position; and
a separation mechanism (6) for mechanically detaching/separating one or more pieces of equipment (E) from the receptacle/receptacles (R) on the tray (T) against a holding force/resistance or for mechanically detaching/separating a part of one or more pieces of equipment (E) from another part with which it is engaged to form a unit while the other part remains held in the receptacle/receptacles (R) on the tray (T) against a holding force/resistance.

2. The apparatus (1) according to claim 1, wherein the locking means (4) for releasably mechanically securing the tray (T) in the working position is configured to engage the tray (T) and actively position the tray (T) into the defined working position.

3. The apparatus (1) according to claim 1- or 2, wherein the locking means (4) for releasably mechanically securing the tray (T) in the defined working position comprises a suction device (5) for gripping a surface of the tray (T) by creating a sub-ambient pressure and for moving the gripped tray (T) into the defined working position.

4. The apparatus (1) according to claim 3, further comprising a means for monitoring the sub-ambient pressure state of the suction device (5).

5. The apparatus (1) according to claim 1, wherein the locking means (4) for releasably mechanically securing the tray (T) in the defined working position comprises a mechanical latch (4a) for releasably locking the tray (T) in the defined working position.

6. The apparatus (1) according to claim 1, wherein the separation mechanism (6) comprises a pushing member (7) for selectively applying a pushing force to a bottom or periphery of the piece of equipment (E) or the part of the unit to overcome the holding force/resistance holding the piece of equipment (E) in the receptacle (R) of the tray (T) or the holding force/resistance engaging the part of the piece of equipment (E) with the other part to form the unit.

7. The apparatus (1) according to claim 6, wherein the pushing member (7) is configured to initially apply the pushing force at an off-centered position to the bottom or periphery of the piece of equipment (E) or the part thereof.

8. The apparatus (1) according to claim 7, wherein the pushing member (7) comprises one or more ejector pins (8) configured to be selectively, preferably phase shifted, urged against the bottom or periphery of the piece of equipment (E), preferably by a linear actuator (9) configured to move one or more ejector pins (8) against the bottom or periphery of the piece of equipment (E) or the part thereof or by a rotary actuator (10) in combination with a cam mechanism (10a, 10b) arranged to linearly drive the one or more ejector pins (8) or by a linear actuator (11) in combination with a lever arm (11a) bearing the ejector pin/pins (8).

9. The apparatus (1) according to claim 1, further comprising a sensor arrangement (12) for monitoring the presence of the tray (T) at the support (3), at the defined working position and/or for monitoring/detecting the presence/absence of one or more pieces of equipment (E) at the receptacles (R) on the tray (T).

10. The apparatus (1) according to claim 9, further comprising a controller configured to, in accordance with the monitoring/detection result of the sensor arrangement (12), issue a warning and/or operate the locking means (4) and/or the separation mechanism (6).

11. A process for handling an equipment-tray assembly (A) which has one or more pieces of equipment (E) held in respective receptacles (R) on a tray (T), preferably using the apparatus (1) according to claim 1, the process comprising
placing the equipment-tray assembly (A) on a support (3) and releasably mechanically securing the tray (T) in a defined working position; and
mechanically detaching/separating one or more pieces of equipment (E) from their receptacle/receptacles (R) on the tray (T) against a holding force/resistance or for mechanically detaching/separating a part of one or more pieces of equipment (E) from another part with which it is engaged to form a unit while the other part remains held in the receptacle/receptacles (R) on the tray (T) against a holding force/resistance.

12. The process according to claim 11, wherein the detaching/separating of the one or more pieces of equipment (E) comprises selectively applying a pushing force to a bottom or a periphery of the piece of equipment (E) or the part thereof to overcome the holding force/resistance holding the piece of equipment (E) in the receptacle (R) of the tray (T) or the holding force/resistance engaging the part of the piece of equipment (E) with the other part to form the unit.

13. The process according to claim 12, wherein the pushing force is initially applied at an off-centered position to the bottom or periphery of the piece of equipment (E) or the part thereof.

14. The process according to claim 11, further comprising monitoring the presence of the tray (T) at the support (3), at the defined working position and/or monitoring/detecting the presence/absence of one or more pieces of equipment (E) at the receptacles (R) on the tray (T).

15. The process according to claim 14, further comprising issuing a warning and/or initiating the securing of the tray (T) in the defined working position and/or the detaching/separating of the one or more pieces of equipment (E) from their receptacle/receptacles (R) or of the parts thereof from the other parts of the respective unit in accordance with the monitoring/detection result.

16. The process according to claim 11, wherein the releasably mechanical securing of the tray (T) in the defined working position is made by creating a sub-ambient pressure to grip the tray (T) and moving the gripped tray (T) into the defined working position; and/or
by engaging a mechanical latch (4a) with the tray (T) placed on the support (3).
